(19) United States
(12) Patent Application Publication
(10) Pub. No.: US 2023/0385506 A1
(43) Pub. Date: Nov. 30, 2023

(54) DEEP REINFORCEMENT LEARNING-BASED INTEGRATED CIRCUIT DESIGN SYSTEM USING PARTITIONING AND DEEP REINFORCEMENT LEARNING-BASED INTEGRATED CIRCUIT DESIGN METHOD USING PARTITIONING

(71) Applicant: AGILESODA INC., Seoul (KR)

(72) Inventors: Pham Tuyen LE, Suwon-si (KR); DoKyoon YOON, Seoul (KR)

(73) Assignee: AGILESODA INC., Seoul (KR)

(21) Appl. No.: 18/296,440

(22) Filed: Apr. 6, 2023

Related U.S. Application Data
(63) Continuation of application No. PCT/KR2022/014074, filed on Sep. 21, 2022.

(30) Foreign Application Priority Data
May 4, 2022 (KR) 10-2022-0055182

(51) Int. Cl. G06F 30/392; G06F 30/3308

(52) U.S. Cl. CPC G06F 30/392; G06F 30/3308

(57) ABSTRACT

The present disclosure may provide parameterized hyperparameter partitioning in consideration of balance in partition size while preserving a property of a hypergraph necessary to apply deep reinforcement learning by reducing the large-size hypergraph, and may reduce the computational amount and capacity of an artificial neural network by reducing a graph.

### CROSS-REFERENCE TO RELATED APPLICATION(S)

Pursuant to 35 USC 120 and 365(c), this application is a continuation of International Application No. PCT/KR2022/014074 filed on Sep. 21, 2022, and claims the benefit under 35 USC 119(a) of Korean Application No. 10-2022-0055182 filed on May 4, 2022, in the Korean Intellectual Property Office, the entire disclosure of which is incorporated herein by reference for all purposes.

### BACKGROUND OF THE INVENTION

### 1. Field of the Invention

The present disclosure relates to a deep reinforcement learning-based integrated circuit design system using partitioning and a deep reinforcement learning-based integrated circuit design method using partitioning and, more particularly to a deep reinforcement learning-based integrated circuit design system using partitioning and a deep reinforcement learning-based integrated circuit design method using partitioning for performing parameterized hyperparameter partitioning in consideration of balance in partition size while preserving a property of a hypergraph necessary to apply deep reinforcement learning by reducing the large-size hypergraph.

### 2. Description of the Prior Art

To manufacture an integrated circuit, various conditions need to be satisfied, and workers manually design the integrated circuit in a design stage.

A worker needs to find an optimal position for manually arranging standard cells, ports, and macros of an integrated circuit in design, thus causing an increase in work time and human resources and a significant decrease in work efficiency.

In addition, since each worker has different skill, mass-produced goods are not uniform.

Reinforcement learning is a learning method for handling an agent that achieves a goal through interaction with an environment, and is widely used in the field of artificial intelligence.

FIG. 1 is a block diagram illustrating a configuration of a general reinforcement learning device, and as shown in FIG. 1, an agent 10 learns a method for determining an action (or activity) A through learning of a reinforcement learning model, each action A affects the next state S, and the degree of success may be measured as a reward R.

That is, the reward is a reward score for an action (activity) determined by the agent 10 according to a state in learning through the reinforcement learning model, and is a type of feedback on decision-making of the agent 100 according to the learning.

An environment 20 is all rules, such as actions taken by the agent 10 and resultant rewards, states, actions, and rewards are all components of the environment, and all predetermined things other than the agent 10 are the environment.

Reinforcement learning is intended to find out which actions a reinforcement learning agent as a main agent of learning needs to perform to receive greater rewards.

That is, the agent learns what to do to maximize a reward even when there is no fixed answer, and experiences a learning process for maximizing a reward by trial and error instead of listening to what action to take in advance and conducting the action in a situation where input and output have a clear relationship.

In addition, the agent sequentially selects an action as a time step passes, and receives a reward based on the impact of the action on the environment.

Recently, considerable research using deep reinforcement learning has been conducted in netlist data including a circuit diagram.

However, since most netlist-related operations increase costs according to the size of the netlist when using such methods, the size of a netlist has become a major issue.

Further, most netlist-based deep reinforcement learning methods are effective for a small netlist, but netlists in real life are generally hypergraphs with enormously large sizes, thus increasing the computational amount and capacity of an artificial neural network according to graph sizes.

In addition, in a large-sized netlist, there is considerable difficulty in learning an artificial neural network and performing inference by using the learned artificial neural network.

### SUMMARY OF THE INVENTION

An aspect of the present disclosure is to provide a deep reinforcement learning-based integrated circuit design system using partitioning and a deep reinforcement learning-based integrated circuit design method using partitioning which are capable of reducing the computational amount and capacity of an artificial neural network for deep reinforcement learning in designing an integrated circuit having a large-size hypergraph on the basis of netlist data.

Further, an aspect of the present disclosure is to provide a deep reinforcement learning-based integrated circuit design system using partitioning and a deep reinforcement learning-based integrated circuit design method using partitioning which perform parameterized hyperparameter partitioning in consideration of balance in partition size while preserving a property of a hypergraph necessary to apply deep reinforcement learning by reducing the large-size hypergraph.

In view of the foregoing aspects, an embodiment of the present disclosure provides a deep reinforcement learning-based integrated circuit design system using partitioning which includes a partition unit to receive and parse netlist data for an arbitrary integrated circuit and to perform partitioning for a standard cell, a port, and a macro on the basis of the parsed netlist data, the partition unit reducing a size of a netlist by reducing a total number of nodes and a number of hyperedges by changing an existing node to a cluster node according to an assigned group in consideration of an area and a quantity of standard cells, a trade-off between an internal network and an external network, and a critical path, deleting duplicate nodes in a hyperedge, and deleting a hyperedge in which only one node remains.

The partition unit according to the embodiment reduces the size of the netlist by calculating a partition size by using a total size of internal vertices and a total number of vertices in a hyperedge through a parameter based on an area coefficient and a route coefficient of a partition in consideration of the area and the quantity of standard cells, the trade-off between the internal network and the external network, and the critical path, and by performing balanced partitioning so that each partition enables a partitioned block of a vertex set satisfies a arbitrary determination criterion in a balance criterion (Lₘₐₓ) for a balance parameter (ε) through an update on a weight for each hyperedge by using the calculated partition size.

The deep reinforcement learning-based integrated circuit design system using partitioning according to the embodiment further includes: a placement optimization unit to simulate the reduced netlist on the basis of state information including meta information about the reduced netlist, current macro information reflecting an action determined by a reinforcement learning agent, and adjacent matrix information, and the action provided from the reinforcement learning agent, and to provide reward information obtained on the basis of placement performance information including wire length, a congestion level, and density in an integrated circuit according to a simulation result as feedback for decision-making of the reinforcement learning agent; and the reinforcement learning agent to perform reinforcement learning to determine an action on the basis of the state information and the reward information provided from the placement optimization unit.

The netlist according to the embodiment is expressed as a hypergraph.

When parameterized partitioning of the netlist is performed, the partition unit according to the embodiment reconstructs the hypergraph by updating hypergraph information, calculates the partition size by using the total size of the internal vertices and the total number of the vertices in the hyperedge in consideration of minimization of a number of partitions and a change in an area of partitions and a number of hyperedges, and performs balanced partitioning so that each partition enables the partitioned block of the vertex set satisfies the arbitrary determination criterion in the balance criterion (Lₘₐₓ) for the balance parameter (ε) through the update on the weight for each hyperedge by using the calculated partition size.

The partition unit according to the embodiment calculates the size of a partition by using the total size of internal vertices and the total number of vertices in the hyperedge on the basis of the area coefficient and the route coefficient of the partition, and the partition size is calculated by an equation below,

$${Size}_{p} = \sqrt{{area}_{coff} \times {\sum }_{v ∈ p} {A}_{v} + {route}_{coff} \times {\sum }_{e ⊂ p} n ( e )} ,$$

where area_{coff} denotes the area coefficient, route_{coff} denotes the route coefficient, Aᵥ denotes an area of a vertex v, and n(e) denotes a number of vertices in a hyperedge e.

The partition unit according to the embodiment updates the weight for each hyperedge by using the calculated partition size, and the weight is calculated by an equation below,

$${W}_{v} = {area}_{coff} \times {A}_{v} + {route}_{coff} \times {\sum }_{e ⊂ p} n ( e )$$

$${W}_{e} = n ( e ) + {SLACK}_{e} ,$$

where Wᵥ denotes a weight for each vertext v, Wₑ denotes a weight for the hyperedge e, area_{coff} denotes the area coefficient, route_{coff} denotes the route coefficient, n(e) denotes the number of vertices in the hyperedge e, and SLACKe denotes a critical path provided in a timing report.

The partition unit according to the embodiment produces a partitioning result having an optimal objective by using a hypergraph partitioning algorithm, and the objective is obtained by a total number of generated partitions+an area of the generated partitions+a sum of external nets being inside the generated partitions but not being completely inside the generated partitions.

Further, an embodiment of the present disclosure provides a deep reinforcement learning-based integrated circuit design method using partitioning which includes step a) receiving and parsing, by a partition unit, netlist data for an arbitrary integrated circuit and performing partitioning for a standard cell, a port, and a macro on the basis of the parsed netlist data, the partition unit reducing a size of a netlist by reducing a total number of nodes and a number of hyperedges by changing an existing node to a cluster node according to an assigned group in consideration of an area and a quantity of standard cells, a trade-off between an internal network and an external network, and a critical path, deleting duplicate nodes in a hyperedge, and deleting a hyperedge in which only one node remains.

The reducing of the netlist in step a) according to the embodiment may include reducing, by the partition unit, the size of the netlist by calculating a partition size by using a total size of internal vertices and a total number of vertices in a hyperedge through a parameter based on an area coefficient and a route coefficient of a partition in consideration of the area and the quantity of standard cells, the trade-off between the internal network and the external network, and the critical path, and by performing balanced partitioning so that each partition enables a partitioned block of a vertex set satisfies a arbitrary determination criterion in a balance criterion (Lₘₐₓ) for a balance parameter (ε) through an update on a weight for each hyperedge by using the calculated partition size.

The deep reinforcement learning-based integrated circuit design method according to the embodiment further includes: b) arranging, by a placement optimization unit, each element of the netlist reduced in step a) by using a trained model, and performing simulation on the basis of state information including meta information about the reduced netlist, current macro information reflecting an action determined by a reinforcement learning agent, and adjacent matrix information, and action information provided from the reinforcement learning agent; and c) evaluating, by the placement optimization unit, a placement result of the reduced netlist by using reward information obtained on the basis of placement performance information including wire length, a congestion level, and density in an integrated circuit according to a simulation result as feedback for decision-making of the reinforcement learning agent.

The netlist according to the embodiment is expressed as a hypergraph.

According to the embodiment, in step a), when parameterized partitioning of the netlist is performed, the partition unit reconstructs the hypergraph by updating hypergraph information, calculates the partition size by using the total size of the internal vertices and the total number of the vertices in the hyperedge in consideration of minimization of a number of partitions and a change in an area of partitions and a number of hyperedges, and performs balanced partitioning so that each partition enables the partitioned block of the vertex set satisfies the arbitrary determination criterion in the balance criterion (Lₘₐₓ) for the balance parameter (ε) through the update on the weight for each hyperedge by using the calculated partition size.

The partitioning according to the embodiment includes calculating the size of a partition by using the total size of internal vertices and the total number of vertices in the hyperedge on the basis of the area coefficient and the route coefficient of the partition, and the partition size is calculated by an equation below,

$${Size}_{p} = \sqrt{{area}_{coff} \times {\sum }_{v ∈ p} {A}_{v} + {route}_{coff} \times {\sum }_{e ⊂ p} n ( e )} ,$$

where area_{coff} denotes the area coefficient, route_{coff} denotes the route coefficient, Aᵥ denotes an area of a vertex v, and n(e) denotes a number of vertices in a hyperedge e.

The partitioning according to the embodiment includes updating the weight for each hyperedge by using the calculated partition size, and the weight is calculated by an equation below,

$${W}_{v} = {area}_{coff} \times {A}_{v} + {route}_{coff} \times {\sum }_{e ⊂ p} n ( e )$$

$${W}_{e} = n ( e ) + {SLACK}_{e} ,$$

where Wᵥ denotes a weight for each vertext v, Wₑ denotes a weight for the hyperedge e, area_{coff} denotes the area coefficient, route_{coff} denotes the route coefficient, n(e) denotes the number of vertices in the hyperedge e, and SLACKe denotes a critical path provided in a timing report.

The partition unit according to the embodiment produces a partitioning result having an optimal objective by using a hypergraph partitioning algorithm, and the objective is obtained by a total number of generated partitions+an area of the generated partitions+a sum of external nets being inside the generated partitions but not being completely inside the generated partitions.

According to the present disclosure, partitioning for a standard cell, a port, and a macro is performed on the basis of parsed netlist data for an arbitrary integrated circuit, in which the area and quantity of standard cells, a trade-off between an internal network and an external network, and a critical path are taken into consideration, a large-size hypergraph may be reduced, thereby reducing the computational amount and capacity of an artificial neural network for deep reinforcement learning.

In addition, according to the present disclosure, a parameterized variable may be added to hypergraph partitioning to thereby perform partitioning in consideration of balance in partition size while preserving a property of a hypergraph necessary to apply deep reinforcement learning when reducing the hypergraph, and the computational amount and capacity of an artificial neural network for deep reinforcement learning may be reduced through reduction of the hypergraph.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a block diagram illustrating a configuration of a general reinforcement learning device;

FIG. 2 is a block diagram illustrating a configuration of a deep reinforcement learning-based integrated circuit design system using partitioning according to an embodiment of the present disclosure;

FIG. 3 is a diagram illustrating a reward process of a placement optimization unit according to the embodiment of FIG. 1;

FIG. 4 is a flowchart illustrating a deep reinforcement learning-based integrated circuit design method using partitioning according to an embodiment of the present disclosure;

FIG. 5 is a flowchart illustrating a netlist reduction process of the deep reinforcement learning-based integrated circuit design method using partitioning according to the embodiment of FIG. 4;

FIG. 6 is a flowchart illustrating a hypergraph partitioning algorithm in the netlist reduction process according to the embodiment of FIG. 5;

FIG. 7 is a diagram illustrating a partition-based netlist reduction process in the netlist reduction process according to the embodiment of FIG. 5;

FIG. 8 is a diagram illustrating a process for partitioning an output partition in a balanced manner in the netlist reduction process according to the embodiment of FIG. 5;

FIGS. 9A to 9C are diagrams illustrating a process for simplifying a representation of a graph in the netlist reduction process according to the embodiment of FIG. 5;

FIG. 10 is a diagram illustrating a result of a test using the deep reinforcement learning-based integrated circuit design method using partitioning according to the embodiment of FIG. 4;

FIGS. 11A to 11C are diagrams illustrating a result of placing an integrated circuit by an expert in the result of the text of FIG. 10;

FIGS. 12A and 12B are diagrams illustrating a result of placing an integrated circuit by using an artificial neural network in the result of the text of FIG. 10;

FIGS. 13A and 13B are diagrams illustrating a result of placing an integrated circuit by using an artificial neural network in the result of the text of FIG. 10;

FIGS. 14A to 14C are diagrams illustrating a result of placing an integrated circuit by using an artificial neural network in the result of the text of FIG. 10; and

FIGS. 15A to 15C are diagrams illustrating a result of placing an integrated circuit by using an artificial neural network in the result of the text of FIG. 10.

### DETAILED DESCRIPTION OF THE EXEMPLARY EMBODIMENTS

Hereinafter, the present disclosure will be described in detail with reference to exemplary embodiments of the present disclosure and the accompanying drawings, in which like reference numerals refer to like elements.

Before a detailed description of the present disclosure is made, it should be noted that a component not directly related to the technical gist of the present disclosure is omitted within the scope of not disturbing the technical gist of the present disclosure.

Terms or words used in the present specification and the claims should be interpreted as having meanings and concepts in accordance with the technical idea of the present disclosure according to the principle that the inventor is able to appropriately define the concept of a term to describe the disclosure in an optimal manner.

In the present specification, the expression that a part “includes” a component means that the part does not exclude another component but may further include another component.

The terms “unit”, “-er”, and “module” refer to a unit of processing at least one function or operation, and may be hardware, software, or a combination of hardware and software.

The term “at least one” is defined as a term including a singular form and a plural form, and it will be apparent that even though the term “at least one” does not exist, each component may exist in a singular form or a plural form and may refer to a singular form or a plural form.

Each component being provided in a singular form or a plural form may be changed according to an embodiment.

Hereinafter, exemplary embodiments of a deep reinforcement learning-based integrated circuit design system using partitioning and a deep reinforcement learning-based integrated circuit design method using partitioning according to an embodiment of the present disclosure will be described in detail with reference to the accompanying drawings.

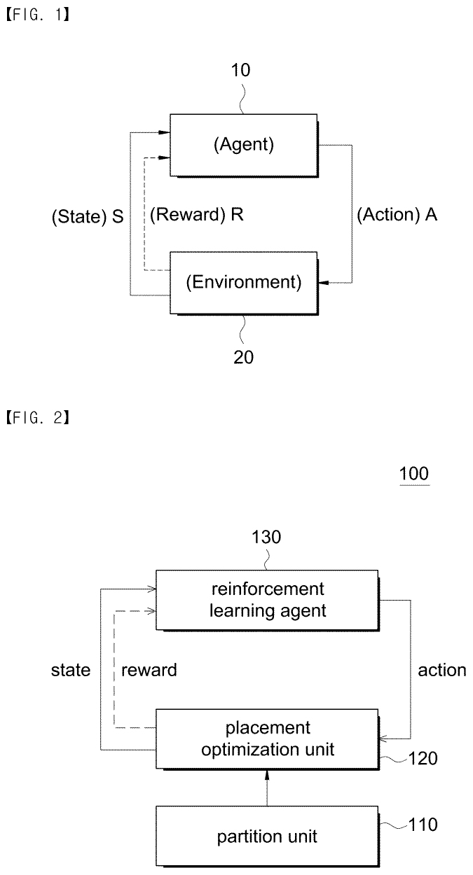

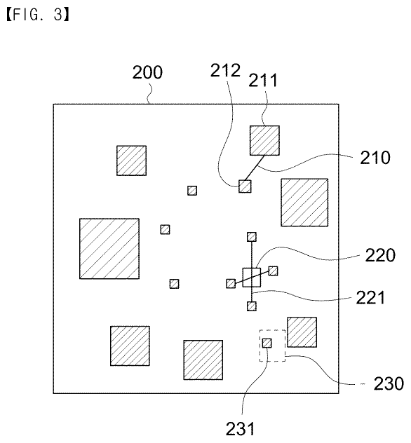

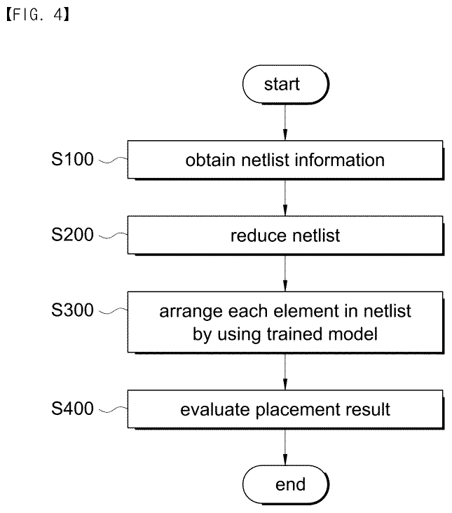

FIG. 2 is a block diagram illustrating a configuration of a deep reinforcement learning-based integrated circuit design system using partitioning according to an embodiment of the present disclosure, and FIG. 3 is a block diagram illustrating a configuration of a placement optimization unit according to the embodiment of FIG. 2.

As illustrated in FIG. 2 and FIG. 3, the deep reinforcement learning-based integrated circuit design system 100 according to the embodiment of the present disclosure may be configured to include a partition unit 110 to provide hyperparameter partitioning in consideration of balance in partition size while preserving a property of a hypergraph necessary to apply deep reinforcement learning by reducing the large-size hypergraph and to add a parameterized variable to existing hypergraph partitioning.

The partition unit 110 may receive and parse netlist data for an arbitrary integrated circuit.

The partition unit 110 may perform partitioning for a standard cell, a port, and a macro on the basis of the parsed netlist data.

The partition unit 110 may perform partitioning in consideration of the area and quantity of standard cells affecting a cluster area, a trade-off between an internal network and an external network, and a critical path, thereby reducing the size of a netlist.

Here, when a hypergraph is reduced through partitioning in the netlist expressed as the hypergraph, it is desirable to prevent information loss by preserving a property of the hypergraph necessary to apply deep reinforcement learning and to perform partitioning in a balanced manner.

To this end, the partition unit 110 may perform parameterized partitioning for the standard cell, the port, and the macro on the basis of the parsed netlist data.

Further, the partition unit 110 may perform partitioning to balance partition sizes through parameterization in consideration of the area and quantity of standard cells affecting the cluster area, the trade-off between the internal network and the external network affecting congestion and wire length, and the critical path (here, a standard cell within the critical path needs to belong to a partition to avoid a negative margin), thereby reducing the size of the netlist.

The netlist may be expressed as a hypergraph.

The hypergraph is a network in which a plurality of vertices or nodes is simultaneously connected to one edge, and may include a hyperedge connecting two or more vertices.

The hypergraph may be defined as a configuration of n vertex sets, m hyperedge sets, a weight corresponding to a vertex, and a weight corresponding to a hyperedge.

Generally, a vertex may correspond to a pin on a netlist on a circuit, and a hyperedge may correspond to a net on a netlist.

A hypergraph partition refers to Pᵢ satisfying Vᵢ∩Vⱼ=Φ when a vertex set V is partitioned into k blocks Π={V₁, . . . , Vₖ) V) and Uᵢ₌₁^{k}Vᵢ=V, Vᵢ≠Φ and i≠j for i where 1≤i≤k.

When each block Vᵢ∈Pᵢ satisfies c(Vᵢ)≤Lₘₐₓ in a balance criterion Lₘₐₓ:=(1+ε) [C(V)/k] for a balance parameter e, each block is referred to as a partition balanced for ε.

When C(Vᵢ)>Lₘₐₓ, each block is regarded as being overloaded, and C(Vᵢ)<Lₘₐₓ, each block is regarded as being underloaded.

A result of hypergraph partitioning may affect a result of deep learning using a graph, and in particular, the result of deep learning using the graph may significantly change depending on the balance of the result of partitioning.

When the parameterized partitioning of the netlist is performed, the partition unit 110 may reconstruct the hypergraph by updating hypergraph information, for example, a vertex set, a hyperedge set, a weight corresponding to a vertex, and a weight corresponding to a hyperedge.

The partition unit 110 may perform partitioning to balance partition sizes in consideration of minimization of the number of partitions and a change in the area of partitions and the number of hyperedges to the outside.

That is, the partition unit 110 may perform partitioning to balance partition sizes through parameterization in consideration of the area and quantity of standard cells, the trade-off between the internal network and the external network, and the critical path, thereby reducing the size of the netlist through partitioning in the hypergraph.

The partition unit 110 may calculate the size of a partition by using a total size of internal vertices and a total number of vertices in a hyperedge on the basis of an area coefficient and a route coefficient of the partition.

The size of the partition may be calculated by Equation 1.

$${Size}_{p} = \sqrt{{area}_{coff} \times {\sum }_{v ∈ p} {A}_{v} + {route}_{coff} \times {\sum }_{e ⊂ p} n ( e )} \qquad [ Equation 1 ]$$

Here, area_{coff} denotes an area coefficient, route_{coff} denotes a route coefficient, Aᵥ denotes the area of a vertex v, and n(e) denotes the number of vertices in a hyperedge e.

The partition unit 110 may update a weight for each hyperedge by using the calculated size of the partition, thereby reconstructing the hypergraph into a simplified hypergraph on the basis of a parameter to achieve balanced partitioning.

The weight may be calculated by Equation 2.

$${W}_{v} = {area}_{coff} \times {A}_{v} + {route}_{coff} \times {\sum }_{e ⊂ p} n ( e ) \qquad [ Equation 2 ]$$

$${W}_{e} = n ( e ) + {SLACK}_{e}$$

Here, Wᵥ denotes a weight for each vertext v, Wₑ denotes a weight for the hyperedge e, area_{coff} denotes the area coefficient, route_{coff} denotes the route coefficient, n(e) denotes the number of vertices in the hyperedge e, SLACKe denotes a critical path provided in a timing report, and Wᵥ, which is the weight for each vertext v, and Wₑ, which is the weight for the hyperedge e, may be updated according to Equation 2.

The vertices are maintained, whereas the hyperedge may be updated by adding a major path on the timing report.

The partition unit 110 may produce a partitioning result having an optimal objective by using a known hypergraph partitioning algorithm, and the objective minimizes the number of partitions and prevents a significant change in the area of the partitions and the number of the hyperedge to the outside.

The objective may be obtained by the total number of generated partitions+the area of the generated partitions+the sum of external nets of the generated partitions.

In addition, the partition unit 110 may produce a plurality of reduced netlists by performing balanced partitioning on the basis of netlist meta information, such as the number of edges, the number of macros, the number of partitions, the width of a chip, and the height of the chip, and macro information, and may select and provide an optimal netlist from among the plurality of produced reduced netlists.

The netlist partitioning system 100 according to an embodiment of the present disclosure may be configured to further include the placement optimization unit 120 and a reinforcement learning agent 130.

The placement optimization unit 120 may simulate the reduced netlist on the basis of state information including meta information about the netlist reduced by the partition unit 110 (e.g., the number of edges, the number of macros, the number of partitions, the width of a chip, and the height of the chip), current macro information (e.g., the width of the macro, the height of the macro, macro X, macro Y, a macro index, and a macro orientation), and adjacent matrix information, and an action provided from the reinforcement learning agent 130.

In addition, the placement optimization unit 120 may provide reward information obtained on the basis of placement performance information including wire length, a congestion level, and density in the integrated circuit according to a simulation result as feedback for decision-making of the reinforcement learning agent 130.

That is, in a placement result 200 shown in FIG. 3, the placement optimization unit 120 may calculate the length 210 of a wire between a first cell 211 and a second cell 212 by using a half-perimeter wire-length (HPWL), and may calculate the congestion level of routing in an arbitrary virtual area 220 and the density of an area 231 disposed in a placement area 230, thereby providing a result of evaluating placement performance.

The reinforcement learning agent 130 may perform reinforcement learning to reduce the netlist by partitioning to balance partition sizes on the basis of the state information and the reward information provided from the placement optimization unit 120.

The reinforcement learning agent 130 may determine an optimal action through the reinforcement learning, and may provide the optimal action to the placement optimization unit 120.

Next, a deep reinforcement learning-based integrated circuit design method using partitioning according to an embodiment of the present disclosure is described.

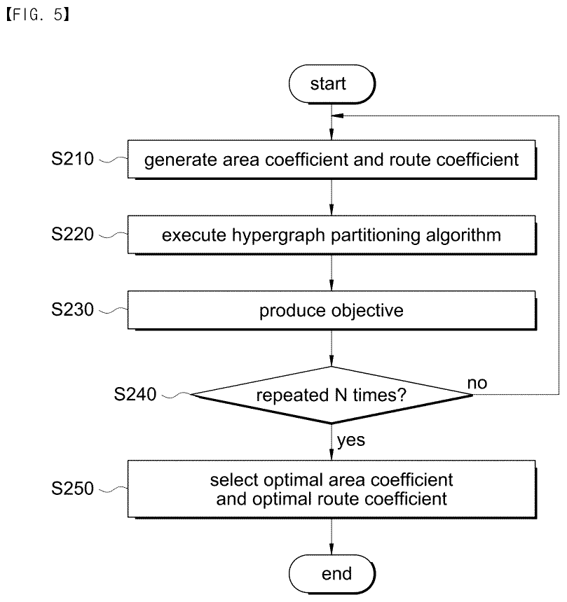

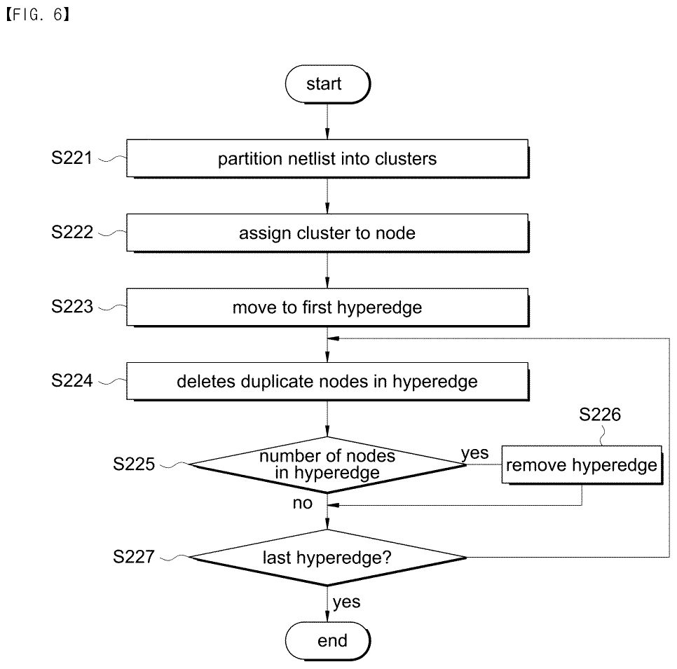

FIG. 4 is a flowchart illustrating a deep reinforcement learning-based integrated circuit design method using partitioning according to an embodiment of the present disclosure, FIG. 5 is a flowchart illustrating a netlist reduction process of the deep reinforcement learning-based integrated circuit design method using partitioning according to the embodiment of FIG. 4, and FIG. 6 is a flowchart illustrating a hypergraph partitioning algorithm in the netlist reduction process according to the embodiment of FIG. 5.

Referring to FIG. 2 and FIG. 4 to FIG. 6, in the deep reinforcement learning-based integrated circuit design method using partitioning according to the embodiment of the present disclosure, the partition unit 110 receives and parses netlist data for an arbitrary integrated circuit (S100).

The partition unit 110 may perform partitioning for a standard cell, a port, and a macro on the basis of the parsed netlist data, and may perform partitioning in consideration of the area and quantity of standard cells affecting a cluster area, a trade-off between an internal network and an external network affecting congestion and wire length, and a critical path (here, a standard cell within the critical path needs to belong to a partition to avoid a negative margin), thereby reducing the size of a netlist (S200).

Reducing the netlist in operation S200 may reduce the size of the netlist by the partition unit 110 performing partitioning to balance partition sizes through parameterization in consideration of the area and quantity of standard cells, the trade-off between the internal network and the external network, and the critical path.

The netlist is a network in which a plurality of vertices or nodes is simultaneously connected to one edge, and may include a hyperedge connecting two or more vertices, and may be expressed as a hypergraph defined as a configuration of n vertex sets, m hyperedge sets, a weight corresponding to a vertex, and a weight corresponding to a hyperedge.

Further, in operation S200, the partition unit 110 may perform partitioning to balance partition sizes by reflecting minimization of the number of partitions and a change in the area of partitions and the number of hyperedges through parameterization in consideration of the area and quantity of standard cells, the trade-off between the internal network and the external network, and the critical path.

When the parameterized partitioning of the netlist is performed, the partition unit 110 may reconstruct the hypergraph by updating hypergraph information, for example, a vertex set, a hyperedge set, a weight corresponding to a vertex, and a weight corresponding to a hyperedge.

In detail, the partition unit 110 generates an area coefficient and a route coefficient of a partition from the parsed netlist (S210).

Further, the partition unit 110 calculates the size of the partition by executing a known hypergraph partitioning algorithm by using the generated area coefficient and route coefficient (S220).

In operation S220, the partition unit 110 may calculate the size of the partition by using a total size of internal vertices and a total number of vertices in a hyperedge on the basis of the generated area coefficient and route coefficient of the partition according to Equation 1.

Further, in operation S220, the partition unit 110 may update a weight for each hyperedge by using the calculated size of the partition, thereby reconstructing the hypergraph into a simplified hypergraph on the basis of a parameter to achieve balanced partitioning.

That is, in the netlist, as shown in FIG. 7, a plurality of nodes may be included in one edge (block), for example, nodes V1, V2, V3, and V4 may be included in a first cluster 310, nodes V3, V4, V5, and V6 may be included in a second cluster 320, nodes V5, V7, and V8 may be included in a third cluster 330, and nodes V6 and V8 may be included in a fourth cluster 340.

The netlist may be expressed as follow.

TABLE 1

| | V1 | V2 | V3 | V4 | V5 | V6 | V7 | V8 |
|---|---|---|---|---|---|---|---|---|
| First | 1 | 1 | 1 | 1 | 0 | 0 | 0 | 0 |
| cluster | | | | | | | | |
| Second | 0 | 0 | 1 | 1 | 1 | 1 | 0 | 0 |
| cluster | | | | | | | | |
| Third | 0 | 0 | 0 | 0 | 1 | 0 | 1 | 1 |
| cluster | | | | | | | | |
| Fourth | 0 | 0 | 0 | 0 | 0 | 1 | 0 | 1 |
| cluster | | | | | | | | |

Alternatively, the netlist may be expressed as dictionary data as follows.

First cluster 310: (V1, V2, V3, V4)

Second cluster 320: (V3, V4, V5, V6)

Third cluster 330: (V5, V7, V8)

Fourth cluster 340: (V6, V8)

In addition, the generated hypergraph may configure the netlist in the form of dictionary data.

Simplification of the hypergraph partitions the netlist into clusters of a first group 300: c1 and a second group 300a: c2 (S221), and a cluster is assigned to each node as follows (S222).

For example, V1:c1, V2:c1, V3:c1, V4:c1, V5:c2, V6:c2, V7:c2, V8:c2 are assigned.

When assignment of S222 is completed, the partition unit 110 moves to a first hyperedge (S223), changes an existing node to a cluster node according to an assigned cluster, and deletes duplicate nodes within the hyperedge (S224).

That is, in operation S224, for example, the first cluster 310: (V1, V2, V3, V4), the second cluster 320: (V3, V4, V5, V6), the third cluster 330: (V5, V7, V8), and the fourth cluster 340: (V6, V8) may be changed to the first cluster 310: (c1, c1, c1, c1), the second cluster 320: (c1, c1, c2, c2), the third cluster 330: (c2, c2, c2), and the fourth cluster 340: (c2, c2).

Also, duplicate nodes may be deleted as follows.

First cluster 310: (c1, c1, c1, c1)→First cluster 310: (c1)

Second cluster 320: (c1, c1, c2, c2)→Second cluster 320: (c1, c2)

Third cluster 330: (c2, c2, c2)→Third cluster 330: (c2)

Fourth cluster (340): (c2, c2)→Fourth cluster (340): (c2)

In addition, a hyperedge with only one remaining node is removed (S226) by determining whether there is one node remaining in a hyperedge, and operations S224 to S226 are repeated until the last hyperedge remains.

That is, the first cluster 310, the third cluster 330, and the fourth cluster 340 in which one node remains may be removed, thereby configuring a simplified hypergraph.

The weight may be calculated by Equation 2, and the vertices may be maintained, but the hyperedge may be updated by adding a major path on a timing report.

Subsequently, the partition unit 110 may produce a partitioning result having an optimal objective, for example, an object to minimize the number of partitions and to prevent a significant change in the area of the partitions and the number of the hyperedge to the outside, by using a known hypergraph partitioning algorithm, and the objective (S230).

Here, the objective may be obtained by the total number of generated partitions+the area of the generated partitions+the sum of external nets of the generated partitions.

The partition unit 110 may repeat operations S210 and S230 a preset number of times (S240).

After performing operation S240, the partition unit 110 may produce a plurality of reduced netlists by performing balanced partitioning on the basis of netlist meta information, such as the number of edges, the number of macros, the number of partitions, the width of a chip, and the height of the chip, and macro information, and may select and provide a reduced netlist having an optimal area coefficient and an optimal route coefficient from among the plurality of produced reduced netlists (S250).

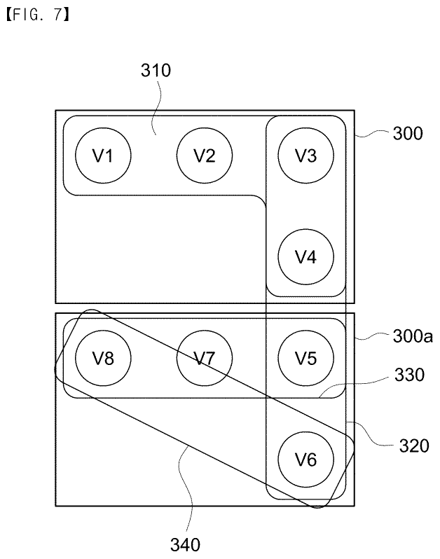

That is, as shown in FIG. 8, in a partition A 400 and a partition B 400a, the reduced netlist having the optimal area coefficient and the optimal route coefficient may be selected on the basis of an internal net 410 completely inside the partition A 400, an external net 420 being inside the partition A 400 but not being completely inside the partition A 400, and a critical path incurring negative slack (slack violation) provided in the timing report.

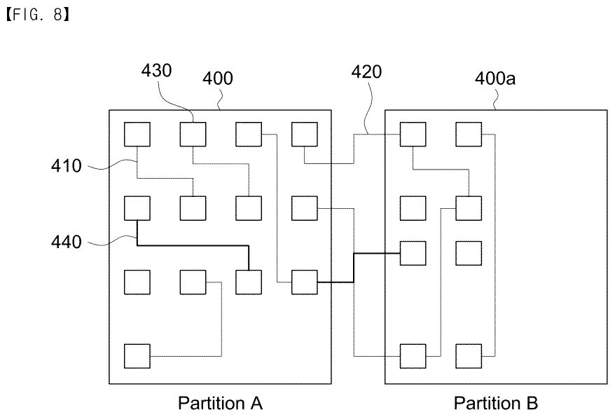

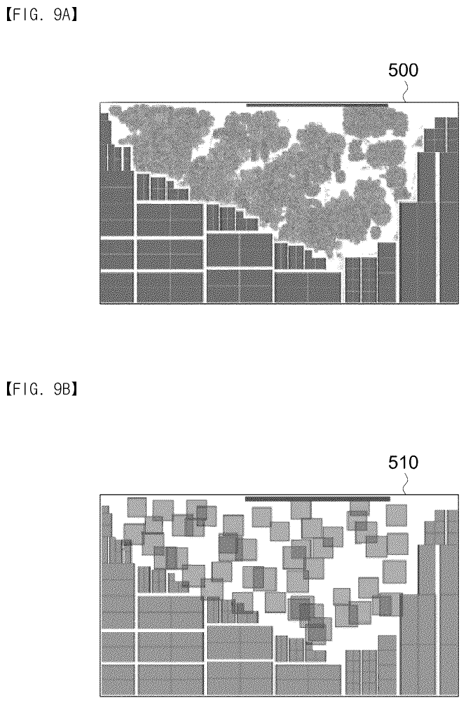

In addition, the same netlist of millions of instances of standard cells, ports, and macros, for example, a netlist image 500 of millions of instances shown in FIG. 9A, may be partitioned to balance partition sizes by reflecting minimization of the number of partitions and a change in the area of partitions and the number of hyperedges to the outside through parameterization in consideration of the area and quantity of standard cells, the trade-off between the internal network and the external network, and the critical path, thereby reconstructing an image 510 physically simplified with hundreds of instances in FIG. 9B and a simplified hypergraph with an image 520 logically simplified with hundreds of instances in FIG. 9C.

Among unexplained reference numerals, 521 denotes a macro area, 522 denotes a standard cell area, and 523 denotes a port area.

Subsequently, the placement optimization unit 120 arranges each element of the netlist reduced in operation S200 by using a trained model, and performs simulation on the basis of state information including meta information about the reduced netlist, current macro information, and adjacent matrix information, and action information provided from the reinforcement learning agent 130 (S300).

In addition, the placement optimization unit 120 may produce reward information obtained on the basis of placement performance information including wire length, a congestion level, and density in the integrated circuit according to a result of the simulation in operation S300 as feedback for decision-making of the reinforcement learning agent 130, and may evaluate a placement result of the reduced netlist by using the produced reward information (S400).

The produced reward information may be learned together with the state information provided from the reinforcement learning agent 130 to perform reinforcement learning to achieve optimal netlist reduction through partitioning to balance partition sizes, and an optimal action may be determined through the reinforcement learning.

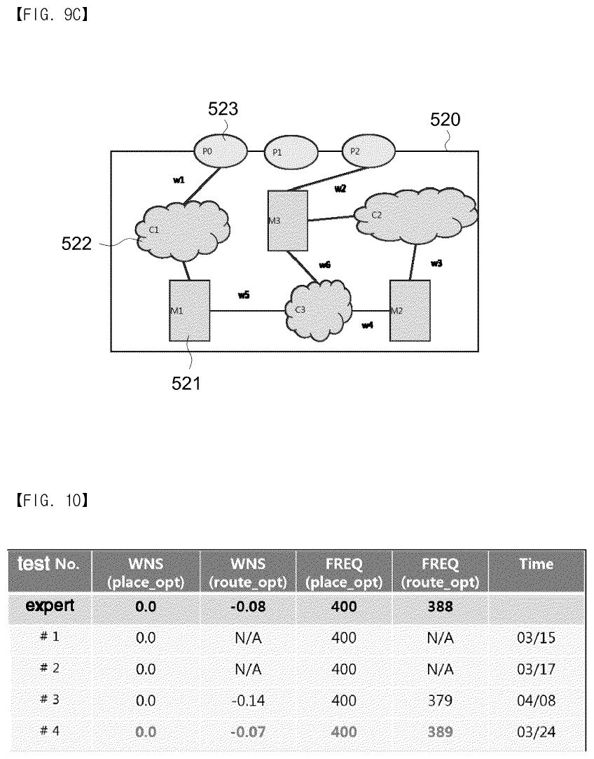

FIG. 10 illustrates a result of a test using the deep reinforcement learning-based integrated circuit design method using partitioning according to an embodiment of the present disclosure, and the result of the test is compared with respect to a WNS and FREQ of a placement result using a graph and a WNS and FREQ of a path generation result with a technique employing an existing algorithm and parameterized hypergraph partitioning.

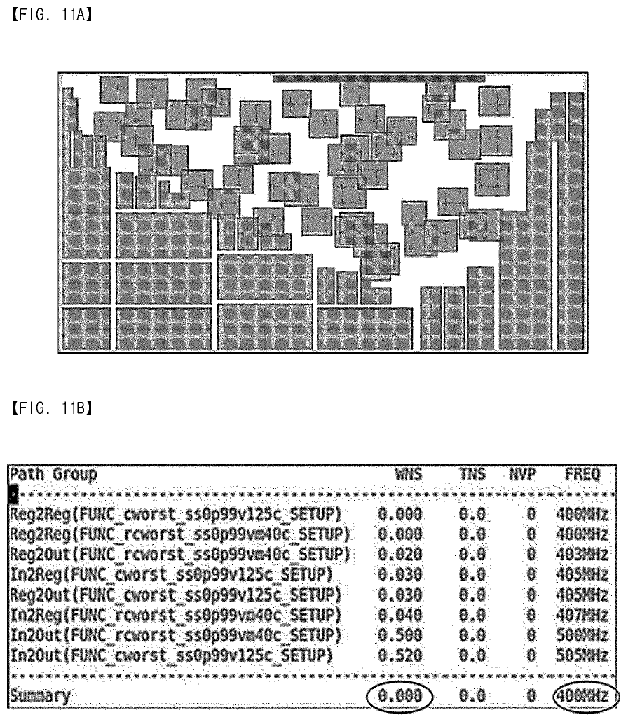

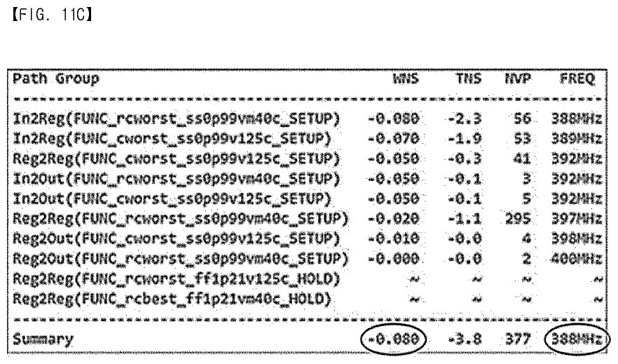

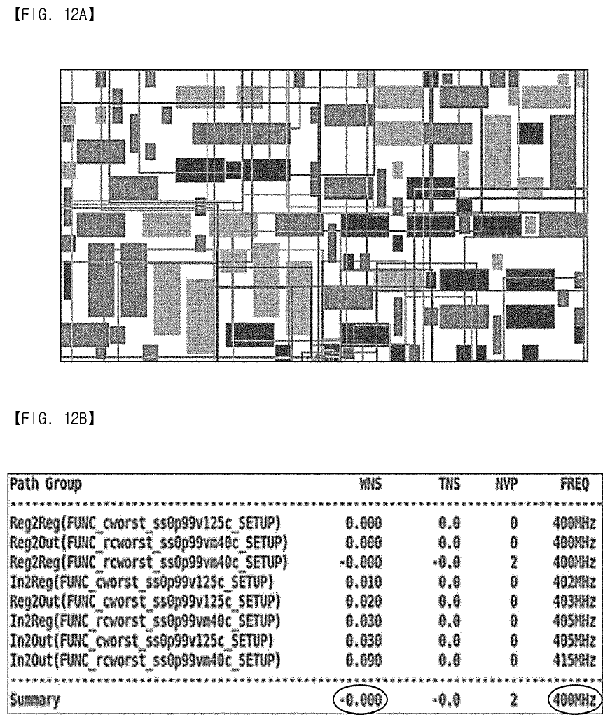

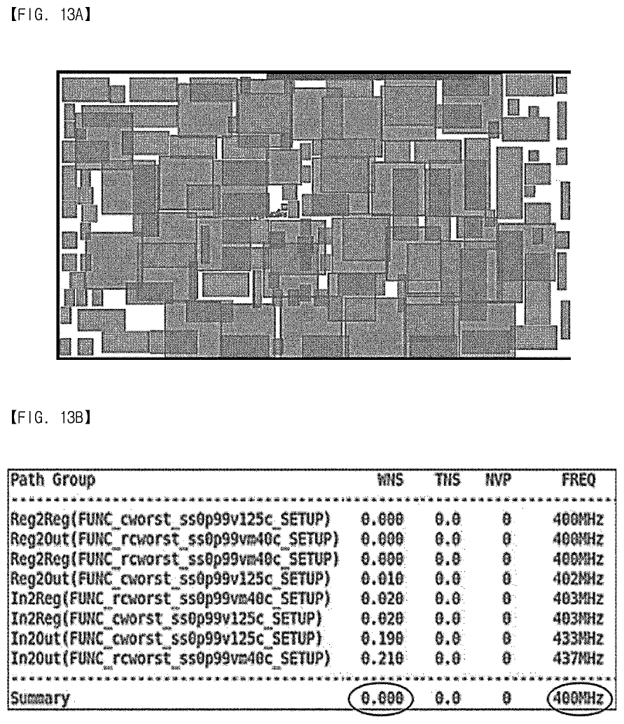

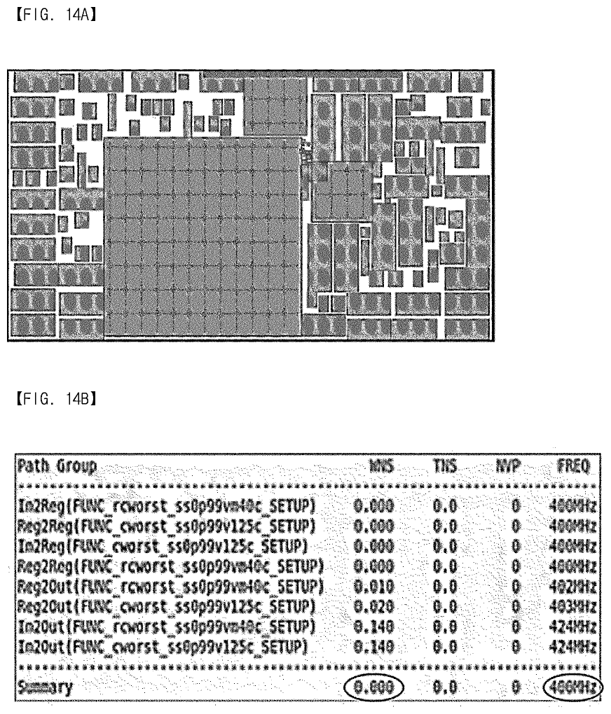

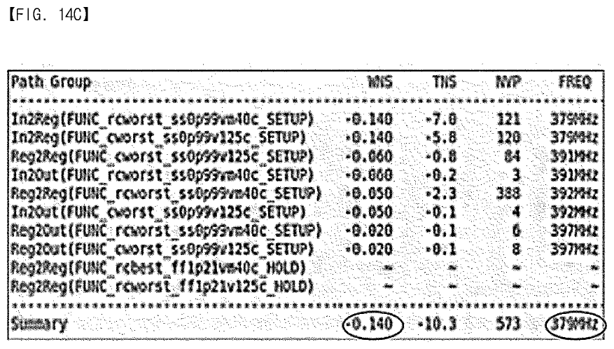

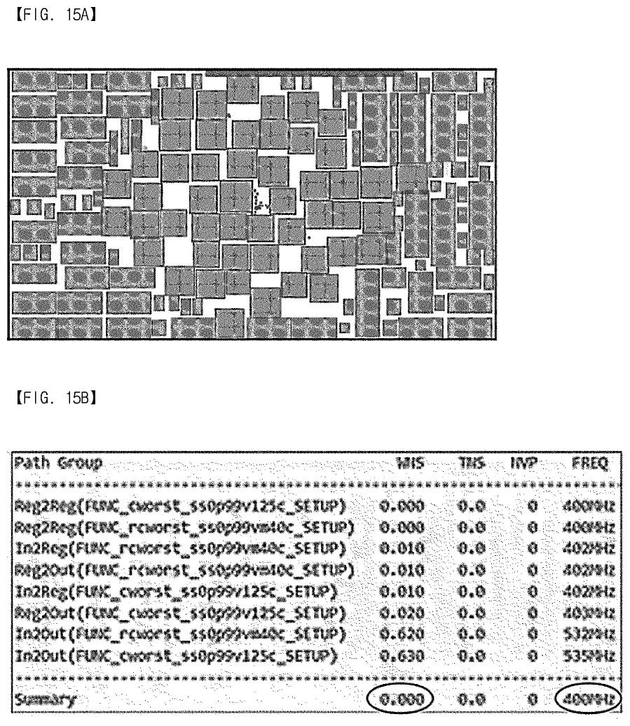

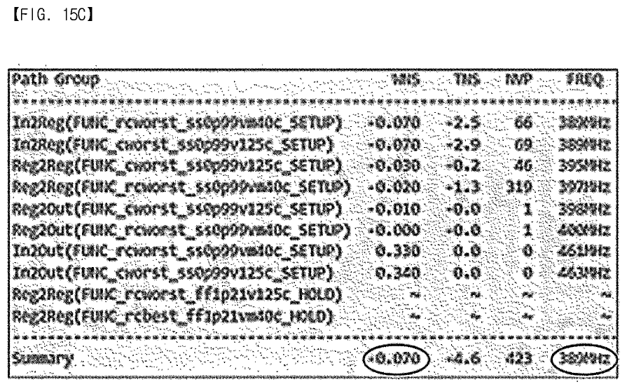

FIGS. 11A to 11C illustrate a result of placing an integrated circuit by an expert, FIGS. 12A and 12B illustrate a result of placing an integrated circuit by applying only a macro orientation, FIGS. 13A and 13B are results of placing an integrated circuit by applying only a macro orientation and a balanced partition, FIGS. 14A to 14C are results of placing an integrated circuit by applying only a macro orientation and a conventional partition, and FIGS. 15A to 15C are results of placing an integrated circuit by applying a macro orientation, a balanced partition, and a position.

As illustrated in FIG. 10, a method (#4) of partitioning a parameterized netlist by using the macro orientation, the balanced partition, and the position has an improved result in WNS and FREQ compared to direct design by the expert.

Therefore, partitioning for a standard cell, a port, and a macro is performed on the basis of parsed netlist data for an arbitrary integrated circuit, in which the area and quantity of standard cells, a trade-off between an internal network and an external network, and a critical path are taken into consideration, a large-size hypergraph may be reduced, thereby reducing the computational amount and capacity of an artificial neural network for deep reinforcement learning.

In addition, a parameterized variable may be added to hypergraph partitioning to thereby perform partitioning in consideration of balance in partition size while preserving a property of a hypergraph necessary to apply deep reinforcement learning when reducing the hypergraph, and the computational amount and capacity of an artificial neural network for deep reinforcement learning may be reduced through reduction of the hypergraph.

As described above, although the present disclosure has been described with reference to exemplary embodiments thereof, it will be understood by those skilled in the art that various changes and modifications may be made in the present disclosure without departing from the spirit and scope of the present disclosure mentioned in the following claims.

Reference numerals mentioned in the claims of the present disclosure are provided only for clarity and convenience of a description, and are not intended to limit the present disclosure, and the thickness of each line or the size of each element illustrated in a drawing in a process of describing an embodiment may be exaggerated for clarity and convenience of a description.

The foregoing terms are defined in view of functions in the present disclosure, and may thus be changed depending on a user, the intent of an operator, or the custom. Accordingly, the terms should be defined on the basis of the following overall description of this specification.

Even though not explicitly illustrated or described, it is apparent that various forms of modifications including the technical idea according to the present disclosure may be made by those having ordinary skill in the art to which the present disclosure pertains from the description of the present disclosure, and these modifications still fall within the scope of the present disclosure.

The foregoing embodiments described with reference to the accompanying drawings have been provided to explain the present disclosure, and the scope of the present disclosure is not limited to these embodiments.

What is claimed is:

1. A deep reinforcement learning-based integrated circuit design system using partitioning, the system comprising:
a partition unit (110) configured to receive and parse netlist data for an arbitrary integrated circuit and perform partitioning for a standard cell, a port, and a macro on the basis of the parsed netlist data,
wherein the partition unit (110) changes an existing node to a cluster node according to an assigned group in consideration of an area and a quantity of standard cells, a trade-off between an internal network and an external network, and a critical path, deletes duplicate nodes in a hyperedge, and deletes a hyperedge in which only one node remains, so as to reduce a total number of nodes and a number of hyperedges, thereby reducing a size of a netlist.

2. The deep reinforcement learning-based integrated circuit design system of claim 1, wherein the partition unit (110) reduces the size of the netlist by calculating a partition size by using a total size of internal vertices and a total number of vertices in a hyperedge through a parameter based on an area coefficient and a route coefficient of a partition in consideration of the area and the quantity of standard cells, the trade-off between the internal network and the external network, and the critical path, and by performing balanced partitioning so that each partition enables a partitioned block of a vertex set satisfies a arbitrary determination criterion in a balance criterion (Lₘₐₓ) for a balance parameter (ε) through an update on a weight for each hyperedge by using the calculated partition size.

3. The deep reinforcement learning-based integrated circuit design system of claim 1, further comprising:
a placement optimization unit (120) configured to simulate the reduced netlist on the basis of state information comprising meta information about the reduced netlist, macro information reflecting an action determined by a reinforcement learning agent (130), and adjacent matrix information, and the action provided from the reinforcement learning agent (130), and to provide reward information obtained on the basis of placement performance information comprising wire length, a congestion level, and density in an integrated circuit according to a simulation result as feedback for decision-making of the reinforcement learning agent (130); and
the reinforcement learning agent (130) to perform reinforcement learning to determine an action on the basis of the state information and the reward information provided from the placement optimization unit (120).

4. The deep reinforcement learning-based integrated circuit design system of claim 1, wherein the netlist is expressed as a hypergraph.

5. The deep reinforcement learning-based integrated circuit design system of claim 4, wherein when parameterized partitioning of the netlist is performed, the partition unit (110) reconstructs the hypergraph by updating hypergraph information, calculates the partition size by using the total size of the internal vertices and the total number of the vertices in the hyperedge in consideration of minimization of a number of partitions and a change in an area of partitions and a number of hyperedges, and performs balanced partitioning so that each partition enables the partitioned block of the vertex set satisfies the arbitrary determination criterion in the balance criterion (Lₘₐₓ) for the balance parameter (ε) through the update on the weight for each hyperedge by using the calculated partition size.

6. The deep reinforcement learning-based integrated circuit design system of claim 5, wherein the partition unit (110) calculates the size of a partition by using the total size of internal vertices and the total number of vertices in the hyperedge on the basis of the area coefficient and the route coefficient of the partition, and
the partition size is calculated by
$${Size}_{p} = \sqrt{{area}_{coff} \times {\sum }_{v ∈ p} {A}_{v} + {route}_{coff} \times {\sum }_{e ⊂ p} n ( e )} ,$$
where area_{coff} denotes the area coefficient, route_{coff} denotes the route coefficient, Aᵥ denotes an area of a vertex v, and n(e) denotes a number of vertices in a hyperedge e.

7. The deep reinforcement learning-based integrated circuit design system of claim 6, wherein the partition unit (110) updates the weight for each hyperedge by using the calculated partition size, and
the weight is calculated by
$${W}_{v} = {area}_{coff} \times {A}_{v} + {route}_{coff} \times {\sum }_{e ⊂ p} n ( e )$$
$${W}_{e} = n ( e ) + {SLACK}_{e} ,$$
where Wᵥ denotes a weight for each vertext v, Wₑ denotes a weight for the hyperedge e, area_{coff} denotes the area coefficient, route_{coff} denotes the route coefficient, n(e) denotes the number of vertices in the hyperedge e, and SLACKe denotes a critical path provided in a timing report.

8. The deep reinforcement learning-based integrated circuit design system of claim 5, wherein the partition unit (110) produces a partitioning result having an optimal objective by using a hypergraph partitioning algorithm, and
the objective is obtained by a total number of generated partitions+an area of the generated partitions+a sum of external nets 420 being inside the generated partitions but not being completely inside the generated partitions.

9. A deep reinforcement learning-based integrated circuit design method using partitioning, the method comprising:
step a) of receiving and parsing, by a partition unit (110), netlist data for an arbitrary integrated circuit and performing partitioning for a standard cell, a port, and a macro on the basis of the parsed netlist data, the partition unit (110) reducing a size of a netlist by reducing a total number of nodes and a number of hyperedges by changing an existing node to a cluster node according to an assigned group in consideration of an area and a quantity of standard cells, a trade-off between an internal network and an external network, and a critical path, deleting duplicate nodes in a hyperedge, and deleting a hyperedge in which only one node remains.

10. The deep reinforcement learning-based integrated circuit design method of claim 9, wherein the reducing of the netlist in step a) comprises reducing, by the partition unit (110), the size of the netlist by calculating a partition size by using a total size of internal vertices and a total number of vertices in a hyperedge through a parameter based on an area coefficient and a route coefficient of a partition in consideration of the area and the quantity of standard cells, the trade-off between the internal network and the external network, and the critical path, and by performing balanced partitioning so that each partition enables a partitioned block of a vertex set satisfies a arbitrary determination criterion in a balance criterion (Lₘₐₓ) for a balance parameter (ε) through an update on a weight for each hyperedge by using the calculated partition size.

11. The deep reinforcement learning-based integrated circuit design method of claim 9, further comprising:
step b) of arranging, by a placement optimization unit (120), each element of the netlist reduced in step a) by using a trained model, and performing simulation on the basis of state information comprising meta information about the reduced netlist, macro information reflecting an action determined by a reinforcement learning agent (130), and adjacent matrix information, and action information provided from the reinforcement learning agent (130); and
step c) of evaluating, by the placement optimization unit (120), a placement result of the reduced netlist by using reward information obtained on the basis of placement performance information comprising wire length, a congestion level, and density in an integrated circuit according to a simulation result as feedback for decision-making of the reinforcement learning agent (130).

12. The deep reinforcement learning-based integrated circuit design method of claim 9, wherein the netlist is expressed as a hypergraph.

13. The deep reinforcement learning-based integrated circuit design method of claim 12, wherein in step a), when parameterized partitioning of the netlist is performed, the partition unit (110) reconstructs the hypergraph by updating hypergraph information,
calculates the partition size by using the total size of the internal vertices and the total number of the vertices in the hyperedge in consideration of minimization of a number of partitions and a change in an area of partitions and a number of hyperedges, and performs balanced partitioning so that each partition enables the partitioned block of the vertex set satisfies the arbitrary determination criterion in the balance criterion (Lₘₐₓ) for the balance parameter (ε) through the update on the weight for each hyperedge by using the calculated partition size.

14. The deep reinforcement learning-based integrated circuit design method of claim 13, wherein the partitioning comprises calculating the size of a partition by using the total size of internal vertices and the total number of vertices in the hyperedge on the basis of the area coefficient and the route coefficient of the partition, and
the partition size is calculated by
$${Size}_{p} = \sqrt{{area}_{coff} \times {\sum }_{v ∈ p} {A}_{v} + {route}_{coff} \times {\sum }_{e ⊂ p} n ( e )} ,$$
where area_{coff} denotes the area coefficient, route_{coff} denotes the route coefficient, Aᵥ denotes an area of a vertex v, and n(e) denotes a number of vertices in a hyperedge e.

15. The deep reinforcement learning-based integrated circuit design method of claim 14, wherein the partitioning comprises updating the weight for each hyperedge by using the calculated partition size, and
the weight is calculated b
$${W}_{v} = {area}_{coff} \times {A}_{v} + {route}_{coff} \times {\sum }_{e ⊂ p} n ( e )$$
$${W}_{e} = n ( e ) + {SLACK}_{e} ,$$
where Wᵥ denotes a weight for each vertext v, Wₑ denotes a weight for the hyperedge e, area_{coff} denotes the area coefficient, route_{coff} denotes the route coefficient, n(e) denotes the number of vertices in the hyperedge e, and SLACKe denotes a critical path provided in a timing report.

16. The deep reinforcement learning-based integrated circuit design method of claim 13, wherein the partition unit (110) produces a partitioning result having an optimal objective by using a hypergraph partitioning algorithm, and
the objective is obtained by a total number of generated partitions+an area of the generated partitions+a sum of external nets 420 being inside the generated partitions but not being completely inside the generated partitions.
